(19) United States
(12) Patent Application Publication
(10) Pub. No.: US 2025/0192438 A1
(43) Pub. Date: Jun. 12, 2025

(54) POWER DISTRIBUTOR, ANTENNA APPARATUS, TRANSMITTER, AND RADAR

(71) Applicant: Furuno Electric Co., Ltd., Nishinomiya-City (JP)

(72) Inventor: Kenichi IIO, Hyogo (JP)

(73) Assignee: Furuno Electric Co., Ltd., Nishinomiya-City (JP)

(21) Appl. No.: 19/060,814

(22) Filed: Feb. 24, 2025

Related U.S. Application Data
(63) Continuation of application No. PCT/JP2023/023709, filed on Jun. 27, 2023.

(30) Foreign Application Priority Data
Aug. 30, 2022 (JP) 2022-136593

(51) Int. Cl. H01Q 9/04; H01P 5/02; H01P 5/12; H01Q 3/34; H01Q 21/08

(52) U.S. Cl. CPC H01Q 9/045; H01P 5/028; H01P 5/12; H01Q 3/34; H01Q 21/08

(57) ABSTRACT

A power distributor includes a dielectric substrate, a rectangular patch resonator, a first input terminal, a first output terminal, and a second output terminal. The rectangular patch resonator is configured to be formed on the dielectric substrate, having a width corresponding to ½ wavelength of a fundamental wave, having an input side and an output side mutually facing, extending in the width direction. The first input terminal is configured to be connected to a first side relative to a center of the input side. The first output terminal is configured to be connected to the first side relative to the center of the output side. The second output terminal is configured to be connected to a second side opposite to the first side relative to the center of the output side.

### CROSS-REFERENCE TO RELATED APPLICATIONS

This application is a continuation application of PCT International Application No. PCT/JP2023/023709, which was filed on Jun. 27, 2023, and which claims priority to Japanese Patent Application No. JP2022-136593 filed on Aug. 30, 2022, the entire disclosures of each of which are herein incorporated by reference for all purposes.

### TECHNICAL FIELD

The present disclosure relates to a power distributor, an antenna apparatus, a transmitter, and a radar.

### BACKGROUND

Traditionally, a rat race circuit is known as a circuit that performs power distribution.

In high-frequency circuits, unwanted radiation problems can arise when the lines of the circuits are affected by sharp bends. The present disclosure has been made in view of the above problems, the main purpose of which is to provide a power distributor, an antenna apparatus, a transmitter, and a radar for easy power distribution while suppressing unwanted radiation.

### SUMMARY

To solve the above problems, a power distributor according to one aspect of the present disclosure includes a dielectric substrate, a rectangular patch resonator formed on the dielectric substrate having a width corresponding to ½ wavelength of a fundamental wave and having an input side and an output side extending in the width direction and facing each other, a first input terminal connected to a first side with respect to a center of the input side, a first output terminal connected to a first side with respect to the center of the output side, and a second output terminal connected to a second side opposite to the first side with respect to the center of the output side. This configuration facilitates power distribution while suppressing unnecessary radiation.

In the above aspect, the power distributor may further include a second input terminal connected to a second side relative to the center of the input side and an opposite phase regulator that adjusts a phase of a fundamental wave input from the second input terminal to the patch resonator in reverse phase with respect to the fundamental wave input from the first input terminal to the patch resonator. With this configuration, it is possible to improve the power distribution characteristics.

In the above aspect, the second input terminal may be connected to a feed line to which the first input terminal is connected via an opposite-phase regulator. With this configuration, it is possible to improve the power distribution characteristics using the common feed line.

In the above aspect, the opposite phase regulator may be a transmission line with a length corresponding to ½ the wavelength of the fundamental wave. According to this, it is possible to improve the power distribution characteristics with a simple configuration.

In the above aspect, the power distributor includes a first set of power distributors and a second set of power distributors. The first set of power distributors includes a patch resonator, a first input terminal, a first output terminal, and a second output terminal. The second set of power distributors includes a patch resonator, a first input terminal, a first output terminal, and a second output terminal. The first input terminal of the first set of power distributors and the first input terminal of the second set of power distributors may be connected to the common feed line. This facilitates further power distribution.

In the above aspect, an intercalated line having a length corresponding to ½ wavelength of the fundamental wave may be provided. One end of the intercalated line is connected to a second side relative to a center of an input side of the patch resonator of the first set of power distributors. The other end of the intercalated line is connected to a second side relative to the center of an input side of the patch resonator of the second set of power distributors. According to this, the intercalated line can further improve the power distribution characteristics.

According to another aspect of the present disclosure, the above-described power distributor includes an antenna apparatus. According to this, it is possible to have a power distributor that can easily distribute power while suppressing an unnecessary radiation.

In the above aspect, the patch resonator may be a patch antenna. According to this configuration, the patch resonator can be used as the patch antenna.

According to another aspect of the present disclosure, the above-described antenna apparatus includes a transmitter. Accordingly, it is possible to provide an antenna apparatus that can easily distribute power while suppressing an unnecessary radiation.

According to another aspect of the present disclosure, the above-described antenna apparatus includes a radar. According to this, it is possible to provide an antenna apparatus that can easily distribute power while suppressing an unnecessary radiation.

### BRIEF DESCRIPTION OF DRAWINGS

FIG. 1 shows an example configuration of a radar.

FIG. 2 shows an example configuration of an antenna apparatus according to a first embodiment.

FIG. 3 shows an example configuration of a power distributor according to the first embodiment.

FIG. 4 shows an example of frequency characteristics according to the first embodiment.

FIG. 5 shows an example configuration of an antenna apparatus according to a second embodiment.

FIG. 6 shows an example configuration of a power distributor according to the second embodiment.

FIG. 7 shows an example of frequency characteristics according to the second embodiment.

FIG. 8 shows an example configuration of a power distributor according to a third embodiment.

FIG. 9 shows an example of a phase characteristic according to the third embodiment.

FIG. 10 shows an example configuration of a power distributor according to a fourth embodiment.

FIG. 11 shows an example of a phase characteristic according to the fourth embodiment.

FIG. 12 shows an example configuration of an antenna apparatus according to the fourth embodiment.

### DETAILED DESCRIPTION

Embodiments of the present disclosure are described below with reference to the drawings.

### [Radar]

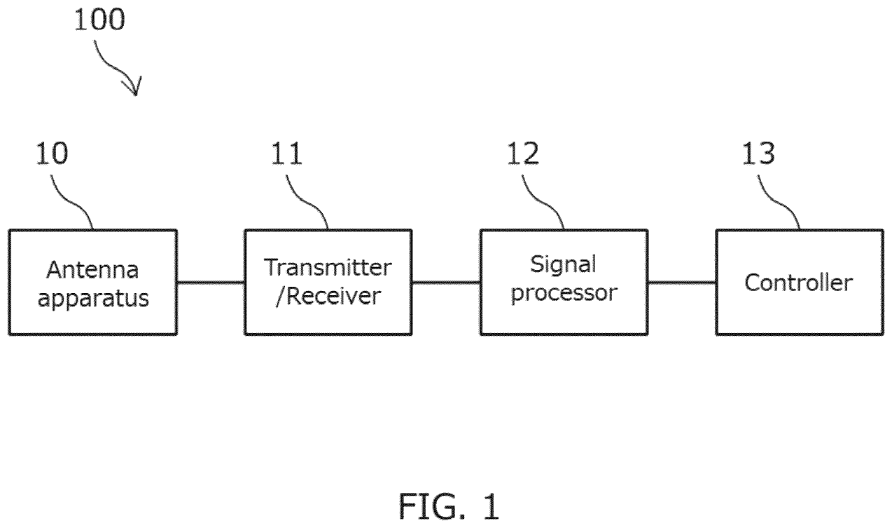

FIG. 1 is a block diagram showing a configuration example of a radar (100) according to the present embodiment. The radar (100) is an example of a transmitter according to the present embodiment and is equipped with an antenna apparatus (10). In addition to the antenna apparatus (10), the radar (100) is equipped with a transmitter/receiver (11), a signal processor (12), and a controller (13).

The transmitter/receiver (11) includes a modulator and a magnetron, which, in response to a trigger signal from the signal processor (12), generates a transmission signal by intermittently driving the magnetron with a pulse voltage generated by the modulator. The antenna apparatus (10) transmits the transmission signal from the transmitter/receiver (11) as a radio wave pulse.

The antenna apparatus (10) converts the received reflected wave into a received signal. The received signal from the antenna apparatus (10) is processed by the signal processor (12) through a frequency conversion/amplification circuit and a detection circuit included in the transmission/reception section (11) and sent to the controller (13) as a digital signal.

The radar (100) may be, for example, a marine radar that transmits and receives microwaves, or an in-vehicle radar that transmits and receives millimeter waves for obstacle detection or collision prevention.

### First Embodiment

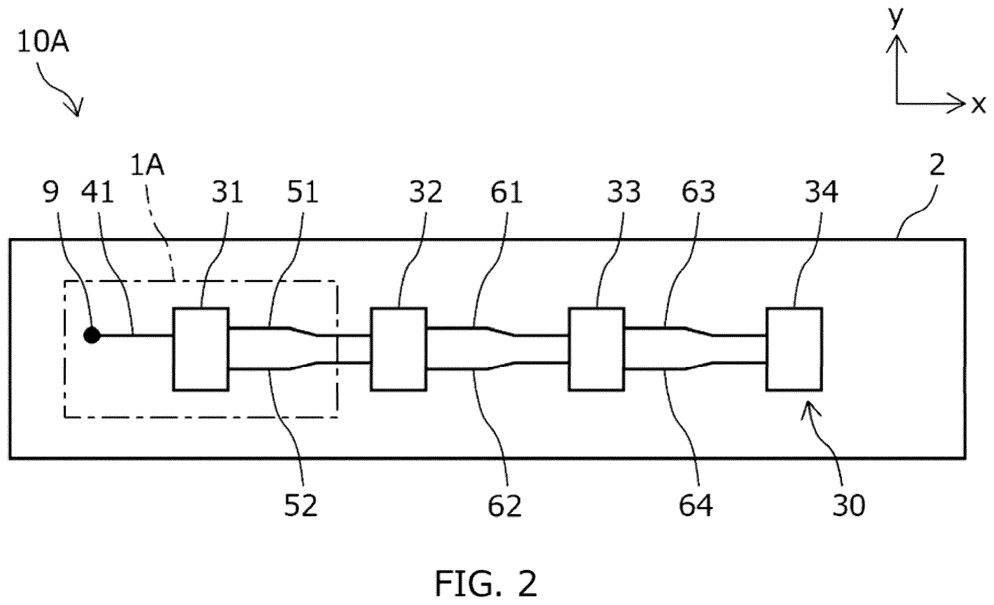

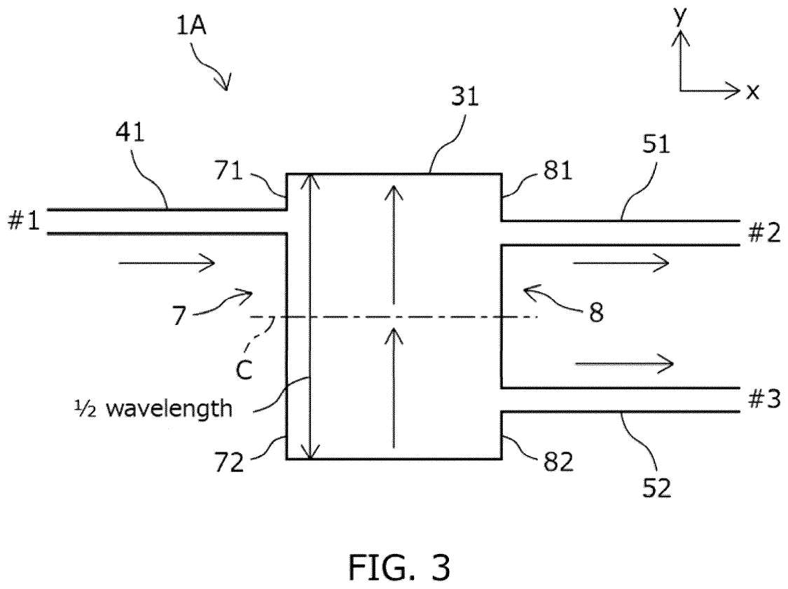

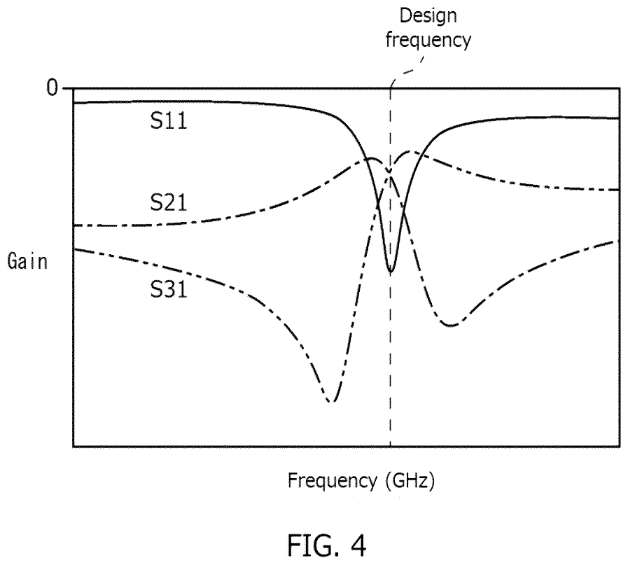

FIG. 2 is a plan view showing a configuration example of an antenna apparatus (10A) according to a first embodiment. FIG. 3 is a partially enlarged view of the antenna apparatus (10A) and a plan view showing a configuration example of a power distributor (1A) according to the first embodiment. FIG. 4 shows an example of a calculation result for frequency characteristics of a scattering matrix of the power distributor (1A).

The antenna apparatus (10A) includes a dielectric substrate (2), an antenna pattern (30) formed on the first main surface of the dielectric substrate (2) (the surface visible in FIG. 2), and a ground pattern (not shown) formed on the second main surface opposite to the first main surface of the dielectric substrate (2). The antenna pattern (30) includes a plurality of patch antennas (31-34). The number of patch antennas is not particularly limited. The patch antenna is a patch resonator.

The antenna apparatus (10A) is a series-fed patch array antenna, and the plurality of patch antennas (31-34) are arranged in one direction and connected in series. In FIG. 2, an x direction is the arrangement direction of the patch antenna (31-34), and a y direction perpendicular to the x direction is a width direction of the patch antenna (31-34).

The antenna pattern (30) is formed, for example, by patterning a metal foil provided on the first main surface of the dielectric substrate (2) using a photolithography technique, thereby integrating the patch antenna (31-34) and transmission lines (41, 51, 52, 61-64) connecting to them.

A feed line (9) is provided at one end of the alignment direction x of the antenna pattern (30). The feed line (9) is connected to an input terminal (41) of the patch antenna (31). The feed line is also referred to as a supply line.

As shown in FIG. 3, the power distributor (1A) includes the patch antenna (31) and the input terminal (41) and output terminals (51) and (52) connected to it. The input terminal (41) is the transmission line that connects the feed line (9) and the patch antenna (31). The output terminals (51 and 52) are the transmission lines that connect the patch antenna (31) and the patch antenna (32).

The patch antenna (31) is rectangular in shape and has the width corresponding to ½ wavelength of a fundamental wave of the frequency used. That is, the width (length in the width direction y) of the patch antenna (31) is approximately equal to ½ wavelength of the fundamental wave.

The patch antenna (31) has a shape that is linearly symmetrical about a centerline (line of symmetry) C passing through a center in the width direction y. When viewed three-dimensionally, the centerline C can also be said to be a plane of symmetry perpendicular to the width direction y.

The patch antenna (31) has an input side (7) and an output side (8) extending in the width direction y and facing the alignment direction x. The input side (7) is the side near the feed line (9), and the output side (8) is the side far from the feed line (9). One input terminal (41) is connected to the input side (7), and two output terminals (51, 52) are connected to the output side (8).

Specifically, the input terminal (41) is connected to a first side (71) (upper side in FIG. 3) with respect to the centerline C of the input side (7). The output terminal (51) is connected to a first side (81) (upper side in FIG. 3) with respect to the centerline C of the output side (8), and the output terminal (52) is connected to a second side (82) (lower side in FIG. 3) opposite to the first side (81) with respect to the centerline C of the output side (8).

The power distributor (1A) uses the patch antenna (31) to distribute power supplied from the input terminal (41) to the two output terminals (51, 52). In FIG. 3, single arrows attached to the input terminal (41), the output terminals (51, 52), and the patch antenna (31) indicate the direction of the high-frequency current at a given moment.

The outputs of the two output terminals (51, 52) are in a phase opposite to each other, i.e., have a phase difference of 180 degrees. With respect to an input of the input terminal (41), the output of the output terminal (51) connected to the same first side (81) as the input terminal (41) is in-phase and the output of the output terminal (52) connected to the opposite second side (82) is in opposite phase.

Two electromagnetic field distributions are generated in the patch antenna (31) with the centerline C as a boundary, and these are extracted from the two output terminals (51 and 52), respectively. In the antenna apparatus (10A), the two outputs from the patch antenna (31) to the output terminals (51 and 52) are input to the patch antenna (32) arranged downstream (see FIG. 2).

In FIG. 4, S11 represents a component input from the input terminal 41 (#1) and is reflected by the input terminal 41 (#1). S21 represents a component passing from the input terminal 41 (#1) to the output terminal 51 (#2). S31 represents a component passing from the input terminal 41 (#1) to the output terminal 52 (#3).

As shown in FIG. 4, at a design frequency, the power input from the input terminal 41 (#1) is evenly distributed between the output terminal 51 (#2) and the output terminal 52 (#3). In a band below the design frequency, the output of the output terminal 51 (#2) is higher, and in a band above the design frequency, the output of the output terminal 52 (#3) is higher.

According to the first embodiment described above, by using the patch antenna (31), it is possible to suppress unnecessary radiation due to the sharp bending of the line while facilitating power distribution.

### Second Embodiment

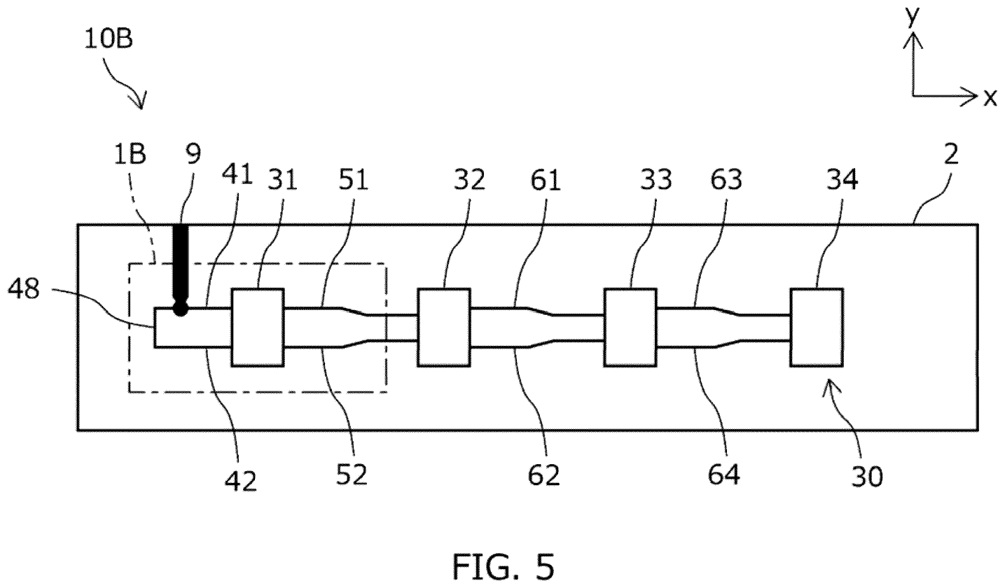

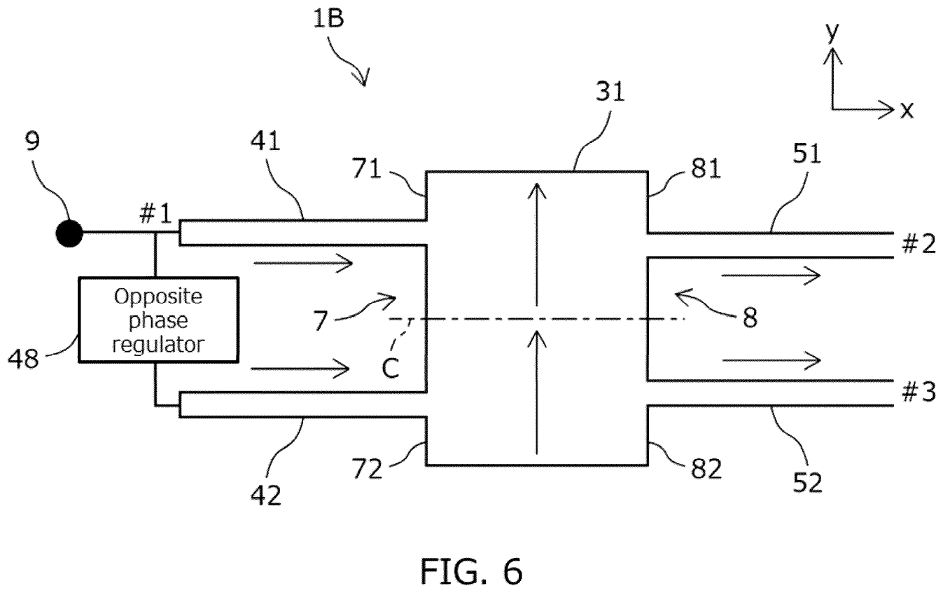

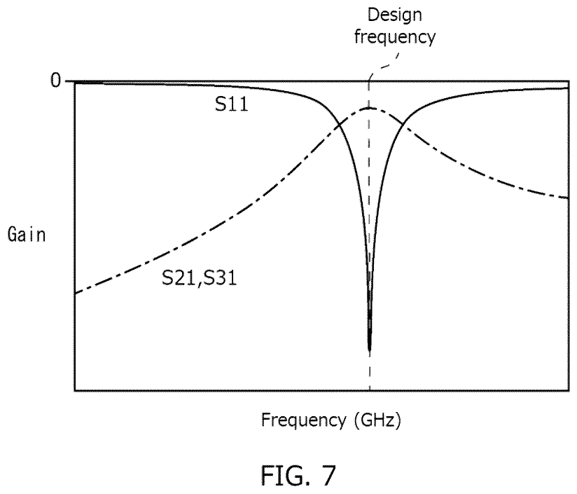

FIG. 5 is a plan view showing a configuration example of an antenna apparatus (10B) according to a second embodiment. FIG. 6 is a partially enlarged view of the antenna apparatus (10B) and a plan view showing a configuration example of a power distributor (1B) according to the second embodiment. FIG. 7 shows an example of a calculation result for frequency characteristics of a scattering matrix of the power distributor (1B). Configurations that overlap with the above embodiment may be given the same reference numerals, and overlapping explanations are omitted.

As shown in FIG. 6, the power distributor (1B) according to the second embodiment further includes an input terminal (42) that is connected to the patch antenna (31) and an opposite phase regulator (48) that adjusts the fundamental wave propagating to the input terminal (42) in reverse phase. The input terminal (42) is connected to a second side (72) (lower side in FIG. 6) with respect to the centerline C of the input side (7) of the patch antenna (31).

The opposite phase regulator (48) adjusts the phase of a fundamental wave input from the input terminal (42) to the patch antenna (31) so that it is opposite to the fundamental wave input from the input terminal (41) to the patch antenna (31). The input terminal (42) is connected to the feed line (9), to which the input terminal (41) is connected via the opposite phase regulator (48).

As shown in FIG. 5, the opposite phase regulator (48) is, for example, an L-shaped or U-shaped transmission line having a length corresponding to ½ the wavelength of the fundamental wave. That is, it functions as the opposite phase regulator (48) by providing a transmission line between the feed line (9) and the input terminal (42) with a length approximately equal to the ½ wavelength of the fundamental wave.

Not limited to this, the opposite phase regulator (48) may be a circuit for adjusting the phase of the fundamental wave to the opposite phase, for example, a rat race circuit or a meander line.

In the power distributor (1A) according to the first embodiment, it is not very easy to excite a TE 20 mode in which the centerline C is an electrically short-circuited surface. This is because when the TE 20 mode is excited, a TE 10 mode is excited at the same time, and the two modes are synthesized by their interaction.

Therefore, in the power distributor (1A) according to the first embodiment, power is distributed equally to the two output terminals (51, 52) at the design frequency, but more power is distributed to the output terminal (51) in the band lower than the design frequency, and more power is distributed to the output terminal (52) in the band higher than the design frequency (see FIG. 4).

On the other hand, in the power distributor (1B) according to the second embodiment, the input terminal (42) is provided in addition to the input terminal (41) and the fundamental waves of opposite phases are input from the input terminals (41, 42) to the patch antenna (31), so that it becomes easy to suppress the TE 10 mode and excite the TE 20 mode in the patch antenna (31).

Accordingly, as shown in FIGS. 7, S21 and S31 are equal not only over the design frequency but also over a relatively wide band. That is, the power input from the input terminals (41 and 42) to the patch antenna (31) is distributed evenly to the output terminals (51 and 52) over a relatively wide band, including the design frequency.

According to the second embodiment described above, it is further possible to achieve desired and stable power distribution characteristics over a relatively wide band.

### Third Embodiment

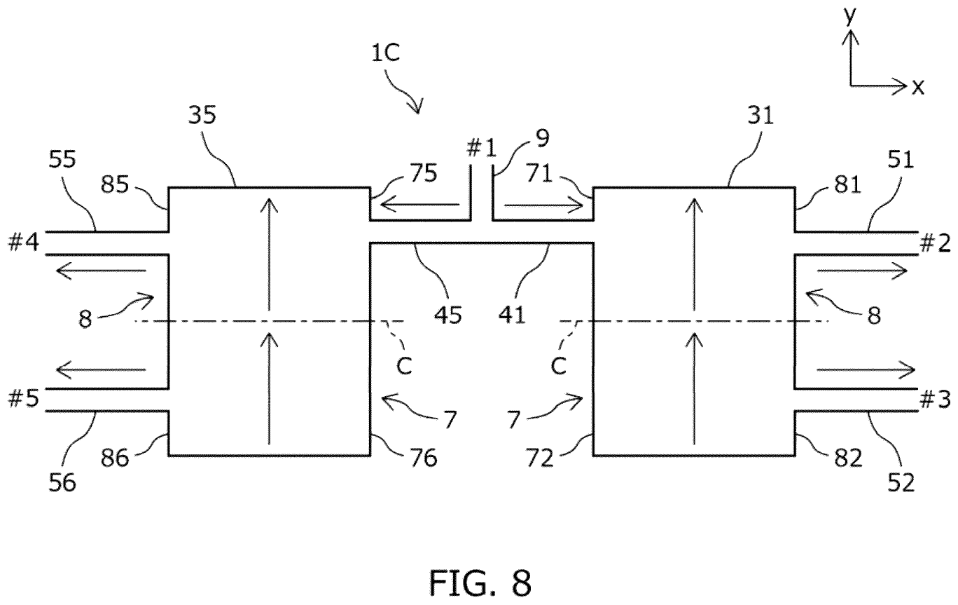

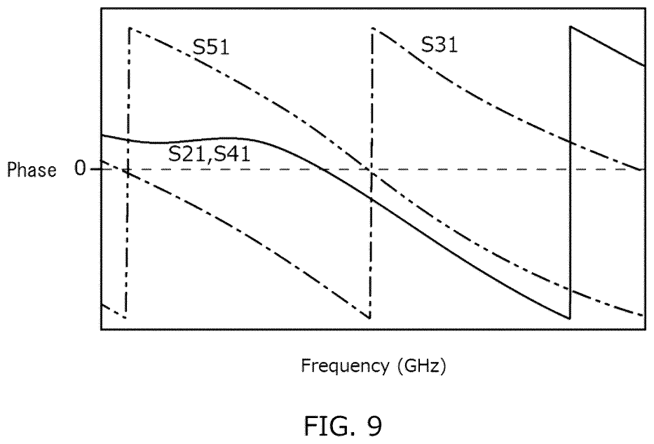

FIG. 8 is a plan view showing a configuration example of a power distributor (1C) according to a third embodiment. FIG. 9 is a diagram showing a calculation result example of phase characteristics of a scattering matrix of the power distributor (1C). Configurations that overlap with the above embodiment may be given the same reference numerals, and overlapping explanations are omitted.

As shown in FIG. 8, the power distributor (1C) according to the third embodiment includes a first set of power distributors and a second set of power distributors. The first set of power distributors includes the patch antenna (31), the input terminal (41), and the output terminals (51 and 52). The second set of power distributors includes a patch antenna (35), an input terminal (45), and output terminals (55 and 56). The input terminal (41) of the first set of power distributors and the input terminal (45) of the second set of power distributors are connected to the common feed line (9).

The patch antenna (35), the input terminal (45), and the output terminals (55, 56) of the second set are configured similarly to the patch antenna (31), the input terminal (41), and the output terminals (51, 52) of the first set of power distributors. That is, the second set of patch antenna (35) is also formed in a rectangular shape and has a width corresponding to ½ wavelength of the fundamental wave of the frequency used. The input terminal (45) is connected to a first side (75) (upper side in FIG. 8) with respect to the centerline C of the input side (7) of the patch antenna (35).

The output terminal (55) is connected to the first side (8) (upper side in FIG. 8) with respect to the centerline C of the output side (8) of the patch antenna (35). The output terminal (56) is connected to a second side 86 (lower side in FIG. 8) opposite to a first side (85) with respect to the centerline C of the output side (8) of the patch antenna (35).

The power distributor (1C) distributes the power supplied from the feed line (9) to the four output terminals (51, 52, 55, and 56) using the patch antennas (31 and 35).

In FIG. 9, S21 represents the component passing from the feed line 9 (#1) to the output terminal 51 (#2). S31 represents the component passing from the feed line 9 (#1) to the output terminal 52 (#3). S41 represents the component passing from the feed line 9 (#1) to the output terminal 55 (#4). S51 represents the component passing from the feed line 9 (#1) to the output terminal 56 (#5).

As shown in FIGS. 9, S21 and S41 are in-phase. On the other hand, S31 and S51 are out of phase (i.e., not in phase).

According to the third embodiment described above, it becomes possible to distribute power to more output terminals (51, 52, 55, and 56).

### Fourth Embodiment

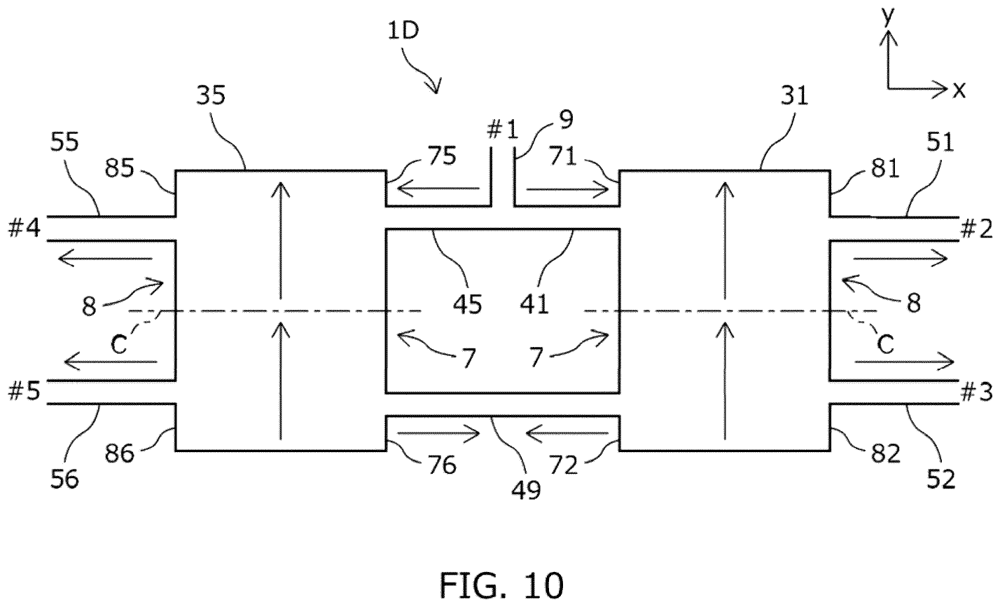

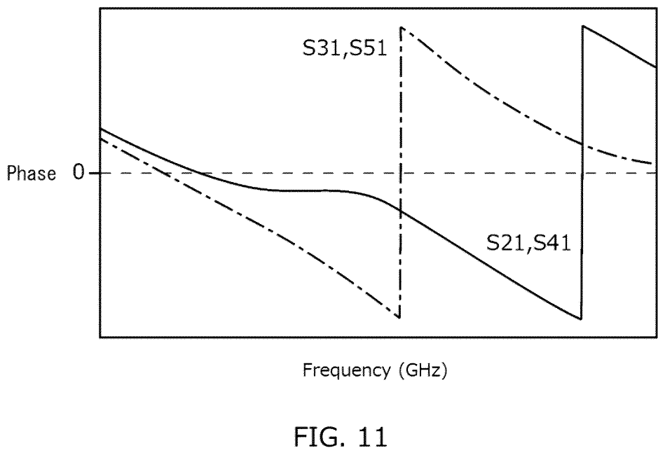

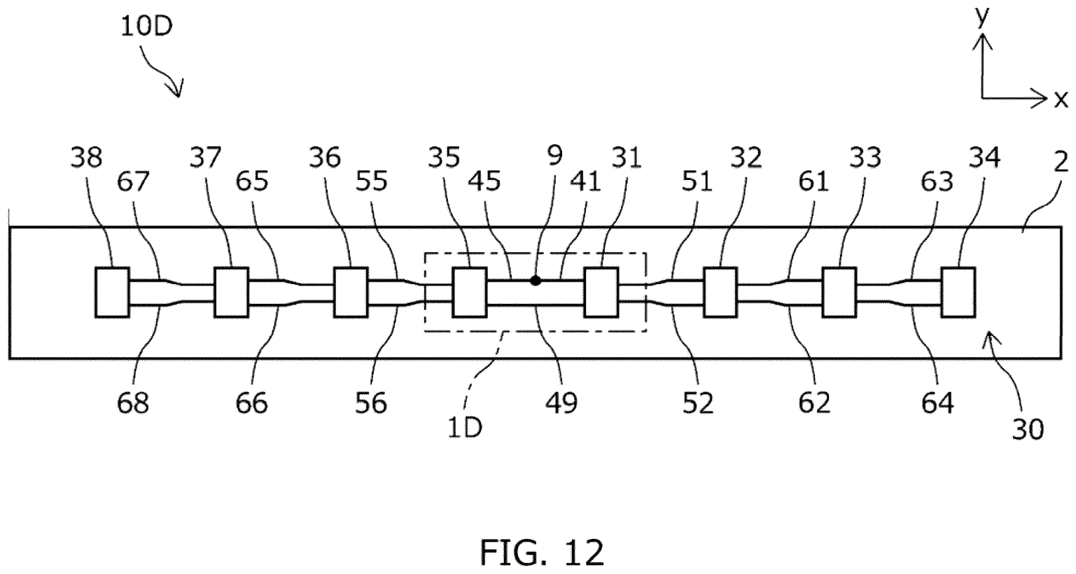

FIG. 10 is a plan view showing a configuration example of a power distributor (1D) according to a fourth embodiment. FIG. 11 shows a calculation result example of a phase characteristics of the scattering matrix of the power distributor (1D). FIG. 12 is a plan view showing a configuration example of an antenna apparatus (10D) with the power distributor (1D). Configurations that overlap with the above embodiment may be given the same reference numerals, and overlapping explanations are omitted.

As shown in FIG. 12, the antenna apparatus (10D) according to the fourth embodiment has the feed line (9) in the center of the antenna pattern (30) in the arrangement direction x, which supplies power to the patch antennas (31 and 35) on both sides.

The output from the patch antenna (31) to output terminals (51 and 52) is further distributed to the patch antennas (32-34). Also, the output from the patch antenna (35) to output terminals (55 and 56) is further distributed to patch antennas (36-38).

As shown in FIG. 10, the power distributor (1D) according to the fourth embodiment further includes an intercalated line (49) interposed between the patch antenna (31) of the first set of power distributors and the patch antenna (35) of the second set of power distributors. The intercalated line (49) is also referred to as a dummy line.

One end of the intercalated line (49) is connected to the second side (72) with respect to the centerline C of the input side (7) of the patch antenna (31) of the first set of power distributors, and the other end is connected to a second side (76) with respect to the centerline C of the input side (7) of the patch antenna (35) of the second set of power distributors.

The intercalated line (49) is a transmission line having a length corresponding to the ½ wavelength of the fundamental wave. That is, the length of the intercalated line (49) from one end connected to the patch antenna (31) to the other end connected to the patch antenna (35) is approximately equal to the ½ wavelength of the fundamental wave.

By connecting the patch antennas (31 and 35) with the intercalated line (49), the power of one of the patch antennas (31 and 35) interferes with the power of the other end through the intercalated line (49), and its symmetry makes it possible to align the phase difference of the outputs of the output terminals (52 and 56).

In the third embodiment, as shown in FIG. 9, an output S31 of the output terminal (52) and an output S51 of the output terminal (56) are not in phase, and are in different phase. In contrast, the fourth embodiment, as shown in FIG. 11, it is shown that the output S31 of the output terminal (52) and the output S51 of the output terminal (56) are in-phase.

According to the fourth embodiment described above, it is possible to distribute power to more output terminals (51, 52, 55, and 56) and to make the outputs of output terminals (52 and 56) as well as output terminals (51 and 55) in-phase.

Although the embodiment of the present disclosure has been described above, the present disclosure is not limited to the embodiment described above, and various modifications are possible for those skilled in the art.

In the above embodiment, an example in which the patch antenna or patch resonator is formed by a micro-strip line has been described, but it is not limited to this; for example, a patch resonator may be formed by a strip line. This makes it possible to distribute power without radiating radio waves.

The patch antenna may ground its center to a ground pattern. This makes it easy to suppress the TE 10 mode and excite the TE 20 mode in the patch antenna.

Hereinafter, representative implementations of the present disclosure are listed below.

The power distributor of this disclosure includes the dielectric substrate, the rectangular patch resonator formed on the dielectric substrate having the width corresponding to ½ wavelength of the fundamental wave and having the input side and the output side extending in the width direction and facing each other, the first input terminal connected to the first side with respect to the center of the input side, the first output terminal connected to the first side with respect to the center of the output side, and the second output terminal connected to the second side opposite to the first side with respect to the center of the output side.

In the above configuration, the device may further include the second input terminal connected to the second side with respect to the center of the input side, and the opposite phase regulator that adjusts the phase of the fundamental wave input from the second input terminal to the patch resonator in reverse phase with respect to the fundamental wave input from the first input terminal to the patch resonator.

In the above configuration, the second input terminal may be connected to the feed line to which the first input terminal is connected via the opposite phase regulator.

The opposite phase regulator may be configured to be the transmission line, with the length corresponding to ½ wavelength of the fundamental wave. It may be configured to have the first set of power distributors and the second set of power distributors, each including the patch resonator, the first input terminal, the first output terminal, and the second output terminal, with the first input terminal of the first set of power distributors and the first input terminal of the second set of power distributors connected to the common feed line.

It may further include the intercalated line of length corresponding to ½ wavelength of the fundamental wave, with one end connected on the second side to the center of the input side of the patch resonator of the first side of power distributors and the other end connected on the second side to the center of the input side of the patch resonator of the second side of power distributors.

The antenna apparatus of the present disclosure includes the power distributor described in any of the above and an antenna that transmits or receives electromagnetic waves connected to the power distributor. The transmitter of the present disclosure transmits electromagnetic waves by means of this antenna apparatus. Here, the patch resonator may be the patch antenna.

The radar in this disclosure is equipped with the antenna apparatus described above, which transmits electromagnetic waves and receives reflected waves from a target.

The various illustrative logical blocks and modules described in connection with the embodiments disclosed herein can be implemented or performed by a machine, such as a processor. A processor can be a microprocessor, but in the alternative, the processor can be a controller, microcontroller, state machine, combination of the same, or the like. A processor can include electrical circuitry configured to process computer-executable instructions. In another embodiment, a processor includes an application-specific integrated circuit (ASIC), a field-programmable gate array (FPGA), or other programmable devices that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in and fully automated via software code modules executed by a computing system that includes one or more computers or processors. The code modules may be stored on any type of non-transitory computer-readable medium or other computer storage device. Some or all of the methods may be embodied in specialized computer hardware.

Many other variations than those described herein will be apparent from this disclosure. For example, depending on the embodiment, certain acts, events, or functions of any of the algorithms described herein can be performed in a different sequence, added, merged, or left out altogether (e.g., not all the described acts or events are necessary for the practice of the algorithms). Moreover, in certain embodiments, acts or events can be performed concurrently, e.g., through multi-threaded processing, interrupt processing, multiple processors or processor cores, or on other parallel architectures, rather than sequentially. In addition, different tasks or processes can be performed by different machines and/or computing systems that can function together.

Conditional language such as, among others, “can,” “could,” “might,” or “may,” unless specifically stated otherwise, is otherwise understood within the context as used in general to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Disjunctive languages such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements, or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved, as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal, as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections or attachments can include direct connections and/or connections having an intermediate structure between the two components discussed.

Numbers preceded by a term such as “approximately,” “about,” and “substantially” as used herein include the recited numbers and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### LIST OF REFERENCE NUMERALS

1 power distributor
2 dielectric substrate
7 input side
8 output side
9 feed line (supply line)
10 antenna apparatus
11 transmitter/receiver
12 signal processor
13 controller
30 antenna pattern
31-38 patch resonator (patch antenna)
41, 42, 45 input terminal
48 opposite phase regulator
49 intercalated line (dummy line)
51, 52, 55, 56 output terminal
61-68 transmission line
71, 75 first side
72, 76 second side
81, 85 first side
82, 86 second side
100 radar (example of the transmitter)

1. A power distributor, comprising:
a dielectric substrate;
a rectangular patch resonator configured to be formed on the dielectric substrate, having a width corresponding to ½ wavelength of a fundamental wave, having an input side and an output side with mutually facing, extending in the width direction;
a first input terminal configured to be connected to a first side relative to a center of the input side;
a first output terminal configured to be connected to a first side relative to the center of the output side; and
a second output terminal configured to be connected to a second side opposite to the first side relative to the center of the output side.

2. The power distributor, according to claim 1, further comprising:
a second input terminal configured to be connected to a second side relative to the center of the input side; and
an opposite phase regulator configured to adjust a phase of a fundamental wave input from the second input terminal to the patch resonator in a reverse phase relative to the fundamental wave input from the first input terminal to the patch resonator.

3. The power distributor, according to claim 2, wherein:
the second input terminal is to be connected to a feed line, to which the first input terminal is connected through the opposite phase regulator.

4. The power distributor, according to claim 3, wherein:
the opposite phase regulator is a transmission line of length corresponding to ½ wavelength of the fundamental wave.

5. The power distributor, according to claim 1, further comprising:
a first set of power distributors including a patch resonator, a first input terminal, a first output terminal, and a second output terminal;
a second set of power distributors including a patch resonator, a first input terminal, a first output terminal, and a second output terminal, respectively; and
the first input terminal of the first set of power distributors and the first input terminal of the second set of power distributors are to be connected to each other via a common feed line.

6. The power distributor, in claim 5, further comprising:
an intercalated line whose length corresponds to ½ wavelength of the fundamental wave; wherein:
one side of the intercalated line is to be connected to a second side relative to a center of an input side of the patch resonator in the first set of power distributors; and
the other side of the intercalated line is to be connected to a second side relative to the center of an input side of the patch resonator in the second set of power distributors.

7. An antenna apparatus, comprising:
a power distributor, including:
a dielectric substrate;
a rectangular patch resonator configured to be formed on the dielectric substrate, having a width corresponding to ½ wavelength of a fundamental wave, having an input side and an output side with mutually facing, extending in the width direction;
a first input terminal configured to be connected to a first side relative to a center of the input side;
a first output terminal configured to be connected to a first side relative to the center of the output side;
a second output terminal configured to be connected to a second side opposite to the first side relative to the center of the output side; and
an antenna configured to transmit and receive an electromagnetic wave through the power distributor.

8. The antenna apparatus according to claim 7, wherein:
the patch resonator is a patch antenna.

9. A radar apparatus, transmitting electromagnetic waves and receiving reflected waves from a target, comprising:
a power distributor, including:
a dielectric substrate;
a rectangular patch resonator configured to be formed on the dielectric substrate, having a width corresponding to ½ wavelength of a fundamental wave, having an input side and an output side with mutually facing, extending in the width direction;
a first input terminal configured to be connected to a first side relative to a center of the input side;
a first output terminal configured to be connected to a first side relative to the center of the output side;
a second output terminal configured to be connected to a second side opposite to the first side relative to the center of the output side; and
an antenna configured to transmit and receive an electromagnetic wave through the power distributor.
